(19) United States
(12) Patent Application Publication
(10) Pub. No.: US 2002/0189912 A1
(43) Pub. Date: Dec. 19, 2002

(54) Thick anchor power band

(76) Inventors: David Landa, Pensacola, FL (US); Edward J. Lee, Chesapeake City, MD (US); Roy Baker, Armore, AL (US)

Correspondence Address: STEPHEN E. FELDMAN, P.C., 12 East 41st Street, New York, NY, 10017, US

(21) Appl. No.: 09/882,249

(22) Filed: Jun. 15, 2001

(51) Int. Cl. F16D 69/00; B60K 17/00

(52) U.S. Cl. 188/259; 180/377

(57) ABSTRACT

The present invention relates to the field of land motor vehicle transmissions. The present invention serves the purpose of increasing the surface area of the brake band and preventing the band anchor from breaking in the land motor vehicle transmission. The present invention has an outer core layer and an inner core layer that are connected with each other using flexible connecters, that are capable of responding and withstanding high pressure and torque. The present invention also has attachment section that is used when the present invention is being attached to a transmission of a land motor vehicle. Each layer also has a multitude of slots that are arranged along surfaces of each layer. The present invention is fabricated from a soft metal to ensure flexibility.

### FIELD OF INVENTION

The present invention relates to the field of land motor vehicle transmission systems. The present invention relates to a holding device that is used by a motor vehicle's automatic transmission. Specifically, the present invention relates a portion of a land motor vehicle's transmission, which prevents a portion of a transmission called the drum from rotating. The present invention may be fabricated from a soft metal, thus making the present invention more flexible. The present invention may be used in vehicles that are used when driving in severe weather conditions and motor vehicles that are used racing vehicles.

### BACKGROUND OF THE INVENTION

There are several known apparatuses for the so-called brake or transmission band assembly to which the present invention relates. These known prior art do not satisfy the criteria that exists in the present invention. Furthermore, the prior art, discussed below, does not achieve the same results as the present invention. The following is a discussion of such prior art and the reasons for the lack of complacency with the parameters that the present invention has.

U.S. Pat. No. 1,488,719 to Sweet teaches an invention relating to brake bands. The brake band has a strip with end clips. The width of the clips is nearly equal to the width of the strip. A sectional lining is applied to the brake band. This prior art concerns improvements to a brake band, in particular, one of the improvements is a sectional lining that may be removed from or applied to a brake band (which would not require a disassembling or removing the brake from its normal position). The sectional lining comprising a plurality of linked sections, each having a radial lug adapted for engaging an edge of a brake strap, and an opposed flat projection adapted for being bent over the other edge of said strap. The present invention comprises of a band manufactured from a soft metal. There are two layers to the present, an outer layer and an inner layer. An inner layer comprises several grooves that run along the circumference of the band in pairs. Furthermore, the present invention comprises an outer layer that is of a certain thickness. Furthermore, said outer layer has grooved section cut out in it so that the band may be used on loads that demand a higher performance and withstand a much larger torque than any conventionally known prior art, including the prior art in question.

U.S. Pat. No. 1,614,084 to Reiner relates to a transmission band for a planetary transmission. The prior art in question teaches a combination of a band having its ends with side lugs, and ears having side portions slidable under the lugs of the band, and the lugs being outstruck from the band. Furthermore, the combination of the band has side lugs, and ears that have notched anchoring portions that the band's lugs engage. The present invention discloses an anchor power band that allows one to use such a band under severe conditions, involving high torque ratios, severe driving conditions, highly uneven pavements and others. The present invention comprises a two-layered structure having an inner layer and an outer layer. Both layers are fabricated from a soft metal allowing much needed flexibility for the band. Said inner and said outer layer further comprise sets of openings that serve to preserve the balance when pressure is applied to the band. Moreover, the inner and outer layers comprise flaps that are of a certain width and thickness, which makes the band more durable when used under severe conditions. The present invention comprises a band of extended width that is able to encompass more area and thicker anchor, thus protecting from any tear-outs.

U.S. Pat. No. 4,787,483 to Stefanutti discloses a slotted circular brake band disposed around a drum of a transmission. Connectors are secured to the ends of the band. A hole extends through the band. This prior art is adapted for wrapping about a portion of the peripheral surface of a drum. The prior art invention comprises a friction lining that has two pairs of slots distributed evenly along the surface of the lining. Furthermore, the band has two pairs of slots that are evenly distributed along the surface of the band. The present invention comprises a two-layered structure having an inner layer and an outer layer. Both layers are fabricated from a soft metal allowing much needed flexibility for the band. Said inner and said outer layer further comprise sets of openings that serve to preserve the balance when pressure is applied to the band. Moreover, the inner and outer layers comprise flaps that are of a certain width and thickness, which makes the band more durable when used under severe conditions. The present invention comprises a band of extended width that is able to encompass more area and thicker anchor, thus protecting from any tear-outs.

U.S. Pat. No. 5,467,849 to Nakagomi et al. teaches a brake band composed of a strip and a brake lining. The lining is provided with grooves and apertures. The brake band is composed of a band portion, such as a metal strap, and a brake lining bonded at an outer peripheral surface thereof on an inner peripheral surface of the band portion and as an apply side end and an anchor side end located opposite to each relative to a circumferential length of the brake band. The brake lining is provided with oil-dependent, friction surface cooling grooves having bottom walls, respectively. Each cooling groove is provided with a discharging aperture extending through the bottom wall of the corresponding cooling groove to the outer peripheral surface of the brake lining. Adjacent to the anchor side end of the brake band, the brake lining is also provided with an oil film formation promoter, for example, in the form of one or more recesses not extending to the outer peripheral surface of the brake lining. As an alternative, the oil film formation promoter can also be provided by leaving the brake lining as is, that is, without forming any recesses, groove, aperture or the line in the vicinity of the anchor side end. The present invention is concerned with a power anchor band for a land motor vehicle transmission. The present invention's purpose is to prevent a drum, which is a portion of a land motor vehicle, from rotating. The present invention comprises of an inner lining and outer core surface. The two portions are connected with each other using conventional means. Furthermore, the present invention is so designed that it has parallel openings along both parts of the invention. The parallel openings are so located as to appear conjointly. Finally, the present invention is manufactured from a soft substance, so as to create a more durable power anchor band, especially when such band is used under high stress and pressure conditions, such as racing or an off-road driving.

The discussed prior art presents a formidable database of information. However, this prior art does not attempt to solve the problems that the present invention is designed to answer. The present invention is a unique variation of a power anchor band that allows driving of a land motor vehicle on rough surfaces or under racing conditions. Due to the specific qualities of the material that is used in manufacturing said power band, the above uses are permitted.

It should be clear to one skilled in the art, that the above discussed prior art is used for the purposes of illustration and should not be construed as limiting in any way, except for the prior art elements claimed in the above patents.

### SUMMARY OF THE INVENTION

The main object of the present invention is to provide for a land motor vehicle's transmission anchor power band.

Another object of the present invention is to provide for a land motor vehicle's transmission anchor power band fabricated from a soft metal.

Another object of the present invention is to provide for a land motor vehicle's transmission anchor power band having an inner lining layer and an outer core layer.

Another object of the present invention is to provide for a land motor vehicle's transmission anchor power band having outer core layer width of 2.620″ and outer core layer thickness of 0.163″.

Another object of the present invention is to provide for a land motor vehicle's transmission anchor power band with inner lining layer comprising openings that are evenly distributed along the surface of the inner lining layer.

Another object of the present invention is to provide for a land motor vehicle's transmission anchor power band with outer core layer comprising openings that are evenly distributed along the surface of the outer core layer and are conjointly aligned with the openings of the inner lining layer.

Other objects of the present invention will become apparent to one skilled in the art from the following description of the present invention's elements. It should, however, be noted that the present invention is not limited to the embodiments disclosed therein. It is understood that the claims that are follow the description cover a variety of embodiments not necessarily disclosed in the present application.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 is a perspective view of the present invention's the outer core layer and the inner lining layer with all of the attachments.

FIG. 1a is a perspective view of the present invention's outer core layer.

FIG. 2 is top view of the present invention showing the outer core layer.

FIG. 3 is a perspective view of the present invention showing portions of the outer core layer and the inner lining layer with appropriate thickness.

FIG. 3a is a perspective view of the present invention of the present invention's anchoring portion.

### DESCRIPTION OF THE PREFERRED EMBODIMENT

The present invention relates to a field of land motor vehicle transmissions. Specifically, the present invention relates to a portion of a land motor vehicle transmission that prevents a portion of the land motor vehicle transmission, called the drum, from rotating. The present invention is designed to be used under severe driving conditions or under heavy commercial operations. Special features of the present invention include extra thickness of the outer core layer and inner lining layer. Furthermore, the present invention has a greater width of the above-mentioned layers. Finally, the present invention, in order to allow a greater flexibility, is fabricated from a soft metals.

In the following description, references to the drawings, certain terms are used for conciseness, clarity and comprehension. It is assumed by one skilled in the art that there are to be no unnecessary limitations implied from the such references, besides the limitations imposed by the prior art, because such terms and references are used for descriptive purposes only and intended to be broadly construed. Furthermore, the description and the drawings are for illustrative purposes only and not to be construed as limited to the exact details shown, depicted, represented, or described.

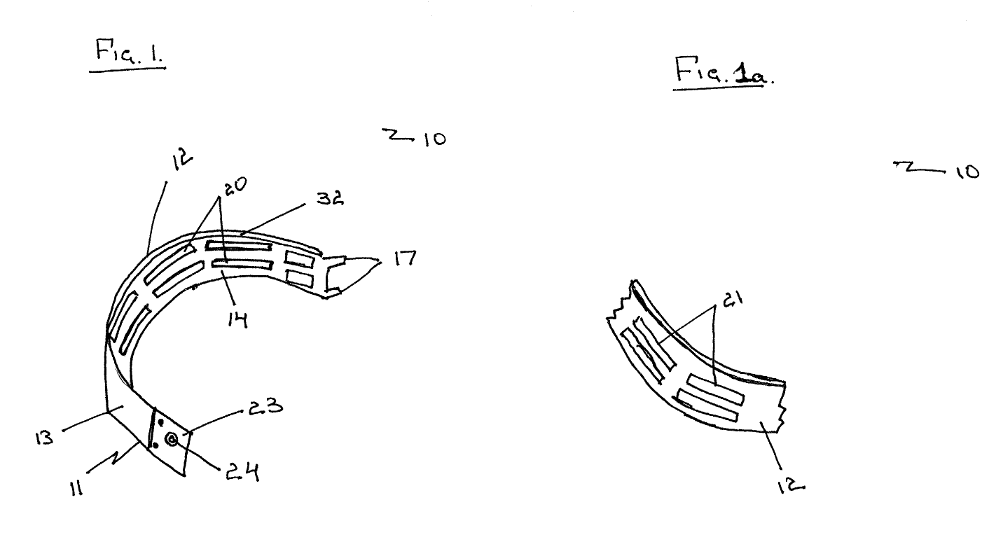

Referring to FIGS. 1 and 1a, the present invention is shown to be a power anchor band 10. As mentioned above, the function of such power anchor band 10 is to prevent the transmission drum from rotating, which allows a use of such band in commercial applications and driving under severe conditions, such as high pressure and friction. The power anchor band 10 is shown to have an outer core layer 12 and an inner lining layer 14. The outer core layer 12 and the inner lining layer 14 are connected using a bonding medium 32, as shown in FIG. 1. The outer core layer 12 has a multitude of outer core layer slots 21, which are arranged to be in pairs, in this particular embodiment. The slots 21, in another embodiment, may, however, be arranged in triplets or any other fashion desired, so to achieve a specified result. The slots 21 serve to create a resonant structure that when pressure is applied to it acts as a spring like mechanism and resists the applied pressure.

The inner lining layer 14 also has a multitude of inner lining layer slots 20, which are arranged in pairs, in this particular embodiment, as shown in FIG. 1. As in the case of the outer core layer 12, the inner lining layer slots 20, may also be arranged in triplets or any other order that is desired to achieve particular results. Furthermore, the slots 20 serve a similar role to the outer core layer slots 21. In conjunction with flexible connecting means 17, slots 20, when pressure is applied, resist such pressure and try to push back into the power band's original shape. Such action allows the drum to stay in its place without rotating.

The outer core layer 12 is attached to the main body of the land motor vehicle's transmission using flexible connecting means 17, which are attached at one end of the outer core layer 12, as shown in FIG. 1. The other end of the outer core layer 12 has an anchoring portion 11 attached to it. Such attachment of the anchoring portion 11 is done through known conventional means, e.g., welding. The anchoring portion 11 has a belt section 13 and a buckling section 23. The buckling section 23 has an anchoring mechanism 24, which holds the power band 10 together with flexible connecting means 17 to the automatic transmission of the land motor vehicle. The band, as depicted in FIG. 1, when in use, encircles the drum, thus, preventing it from rotating. When using a common conventional band, slippage and breakage are common elements and causes of malfunctioning of transmissions of land motor vehicles. The present invention resolves such problem by presenting a unique configuration that is capable of withstanding high magnitudes of pressure and friction. This is especially helpful, as was mentioned above, when such vehicle is used under severe operating conditions and in heavy-duty commercial applications.

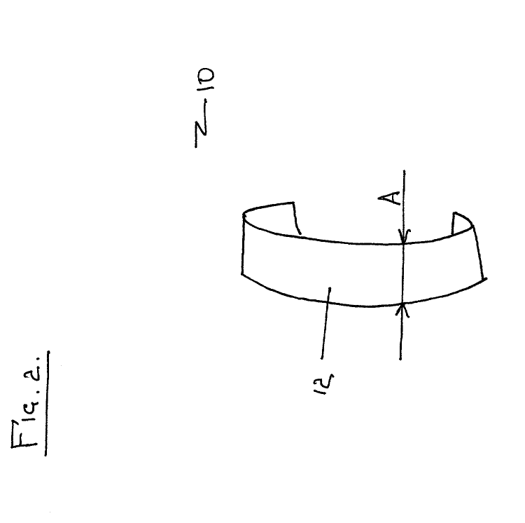

Referring to FIG. 2, the power anchor band 10 is shown from the top revealing a portion of the outer core layer 12 to view. The outer core layer 12 is shown to have width “A”. In one embodiment, width “A” is 2.620″. The extra width of the power band 10 is another important factor that prevents the transmission's drum from rotating. In this particular embodiment, the width “A” is 18% more surface area than any conventionally known band. This results in a maximum performance and durability of the power anchor band 10.

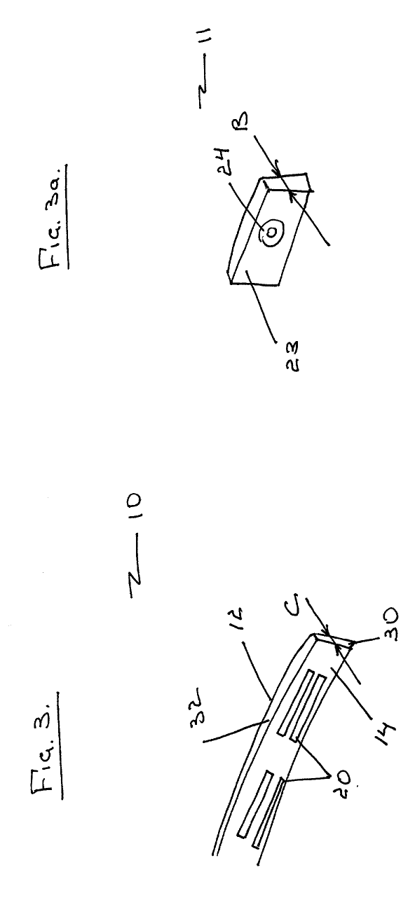

Referring to FIGS. 3 and 3a, a portion of the power anchor band 10 is shown. FIG. 3 shows the outer core layer 12, the inner lining layer 14, and inner lining layer slots 20. The outer core layer 12 and the inner lining layer 14 are shown to have sides 30, when combined have a thickness “C”, as shown in FIG. 3. As shown in FIG. 3a, the buckling section 23 is shown to have a thickness “B”. In this particular embodiment, thickness “B” may be 0.163″. This particular thickness magnitude is greater than any conventionally known band thickness and it ensures that when the power anchor band 10 is in use there is no extrusion tear out. This quality is extremely important when the band 10 is holding a transmission drum of a land motor vehicle when the latter is used under heavy stress. The width “A” and thickness “B” and “C” together provide for a power band that ensures performance when the land motor vehicle is operated under heavy duty, commercial, high performance and in racing applications, where a torque and pressure that are applied are much higher and longer than in any normal use.

Finally, the power anchor band 10 is fabricated from a soft metal, thus, allowing an easier removal of the band and greater flexibility, yet retaining an important factor of durability. Any variety of soft conventionally known metals or combination of such metals may be used to produce the desired results.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. An anchor power band attached to a transmission of a land motor vehicle, comprising an outer layer;
an inner layer connected to said outer layer;
outer layer openings located in said outer layer;
inner layer openings located in said inner layer;
flexible connection means;
an anchoring portion, wherein said anchoring portion further comprising
i. a belt section attached to said core;
ii. a buckling section attached to said belt section, wherein
1. said buckling section has an anchoring mechanism.

2. The anchor power band of claim 1, wherein said outer layer has a width.

3. The anchor power band of claim 2, wherein said width is 2.620 inches.

4. The anchor power band of claim 2, wherein said inner layer has said width.

5. The anchor power band of claim 1, wherein said outer layer openings are arranged in pairs along a surface of said outer layer.

6. The anchor power band of claim 1, wherein said inner layer openings are arranged in pairs along a surface of said inner layer openings.

7. The anchor power band of claim 1, wherein said outer layer has a thickness.

8. The anchor power band of claim 7, wherein said thickness is 0.163 inches.

9. The anchor power band of claim 1, wherein said power band is manufactured using conventionally known metals having softness and flexibility as their primary qualities.

10. An anchor power band attached to a transmission of a land motor vehicle, comprising an outer layer;
an inner layer connected to said outer layer;
outer layer openings located in said outer layer;
inner layer openings located in said inner layer;
flexible connection means;
an anchoring portion, wherein said anchoring portion further comprising
i. a belt section attached to said outer layer;
ii. a buckling section attached to said belt section
1. said buckling section has an anchoring mechanism;
said outer layer openings are arranged in pairs along a surface of said outer layer;
said inner layer openings are arranged in pairs along a surface of said inner layer openings;
said power band is manufactured using conventionally known metals having softness and flexibility as their primary qualities.

11. The anchor power band of claim 10, wherein said outer layer has a width.

12. The thick anchor power band of claim 11, wherein said width is 2.620 inches.

13. The anchor power band of claim 11, wherein said inner layer has said width.

14. The anchor power band of claim 10, wherein said outer layer has a thickness.

15. The anchor power band of claim 14, wherein said thickness is 0.163 inches.
